(19) United States
(12) Patent Application Publication
(10) Pub. No.: US 2014/0131423 A1
(43) Pub. Date: May 15, 2014

(54) FETCHING MECHANISM AND AUTOMATIC WELDING SYSTEM USING THE SAME

(71) Applicants: HON HAI PRECISION INDUSTRY CO., LTD., New Taipei (TW); FU DING ELECTRONICAL TECHNOLOGY (JIASHAN) CO.,LTD., Zhejiang (CN)

(72) Inventors: JIN-HUA LU, Jiashan (CN); DA-ZHUANG XU, Jiashan (CN); DA-XIANG ZHOU, Jiashan (CN); NAN LV, Jiashan (CN)

(73) Assignees: HON HAI PRECISION INDUSTRY CO., LTD., New Taipei (TW); FU DING ELECTRONICAL TECHNOLOGY (JIASHAN) CO.,LTD., Zhejiang (CN)

(21) Appl. No.: 14/076,368

(22) Filed: Nov. 11, 2013

(30) Foreign Application Priority Data
Nov. 13, 2012 (CN) 2012205953240

(51) Int. Cl. B23K 37/04

(52) U.S. Cl. CPC B23K 37/04
USPC 228/43; 228/47.1

(57) ABSTRACT

A fetching mechanism includes a support base, a fetching member positioned on the support base and an adsorbing assembly. The adsorbing assembly is positioned on the support base and is spaced from the fetching member. The adsorbing assembly includes a driving member positioned on the support base and an adsorbing member driven by the driving member. The fetching member fetches one welding member, the adsorbing member is driven by the driving member to extend out and adsorbs the workpiece, and the adsorbing member is driven to drawback until each welding member attaches the workpiece. The application also supplies an automatic welding system using the fetching mechanism.

### BACKGROUND

1. Technical Field

The present disclosure generally relates to fetching mechanisms, and particularly to a fetching mechanism for fetching welding members and workpieces during a welding process, and an automatic welding system using the fetching mechanism.

2. Description of the Related Art

Welding members, such as bolts, may be welded to a workpiece for structure fixation. Usually, welding members are manually positioned in preset positions of a patrix, and the patrix is moved to a bottom die positioning the workpiece for assembly. Then the welding members are positioned in preset welding positions of the workpiece. A welding machine is applied to weld the welding members on the workpiece. The patrix is moved off and the workpiece is taken off after a welding process. However, manual fetching the welding members is time and labor consuming. In addition, it is not safe for operators.

Therefore, there is room for improvement within the art.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows an assembled, isometric view of an embodiment of an automatic welding system using a fetching mechanism.

FIG. 2 shows an assembled, isometric view of the fetching mechanism of FIG. 1.

FIG. 3 shows a partial, exploded view of the fetching mechanism of FIG. 2.

FIG. 4 is similar to the FIG. 3, but from another aspect.

FIG. 5 shows a working state of the fetching mechanism of FIG. 2.

### DETAILED DESCRIPTION

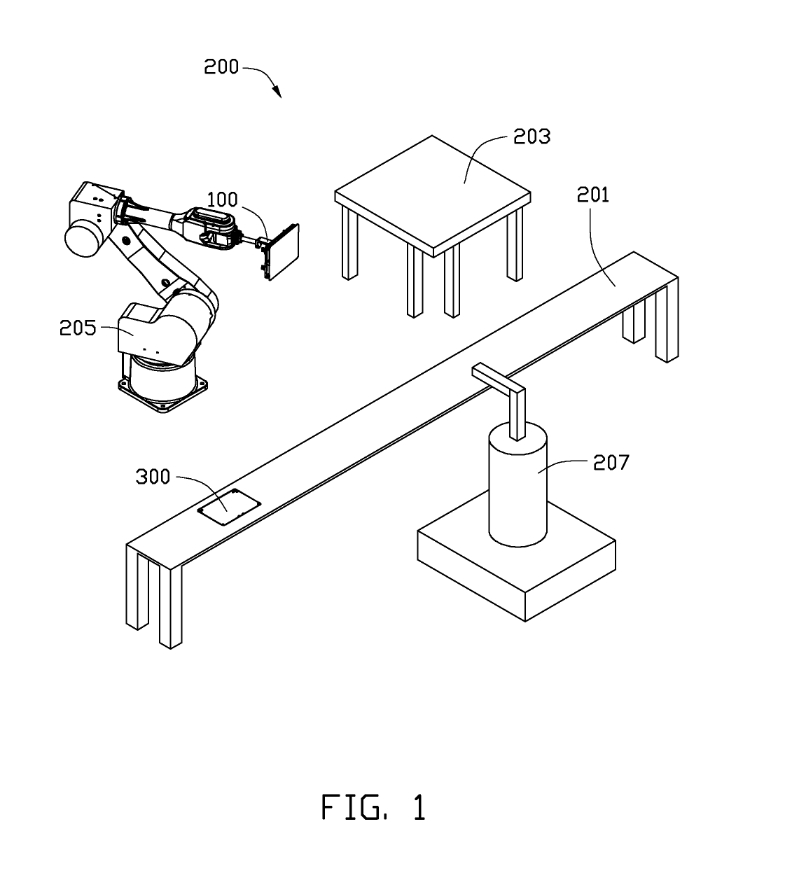

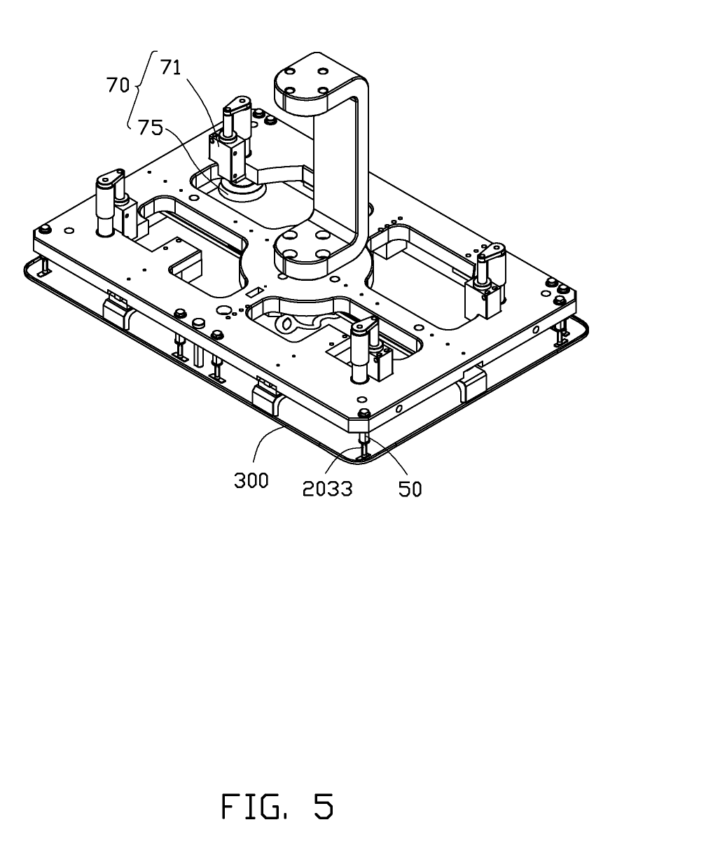

FIG. 1 shows an automatic welding system 200 using a fetching mechanism 100. The automatic welding system 200 usually further includes a conveyor belt 201, a loading platform 203, a robot arm 205, and a welding machine 207. The loading platform 203 and the robot arm 205 are separately positioned in a same side of the conveyor belt 201. Welding members 2033 (shown in FIG. 5) are arranged in preset positions on the loading platform 203. In the illustrated embodiment, the welding members 2033 are bolts. An operation groove (not shown) is formed in a top of each welding member 2033 for conventional operation. The welding machine 207 is located at another side of the conveyor belt 201 and faces to the robot arm 205. The fetching mechanism 100 is fixedly installed on the robot arm 205 for fetching welding members 2033 from the loading platform 203 and adsorbing a workpiece 300. The fetching mechanism 100 also attaches the welding members 2033 to their preset welding positions for welding.

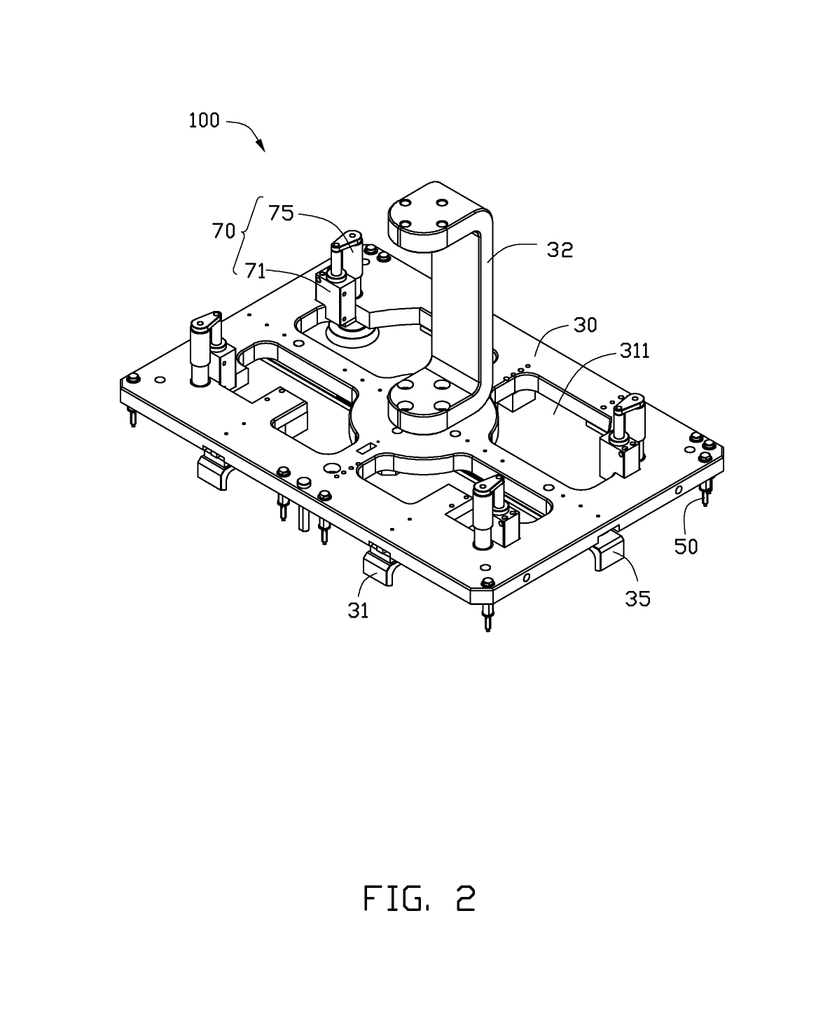

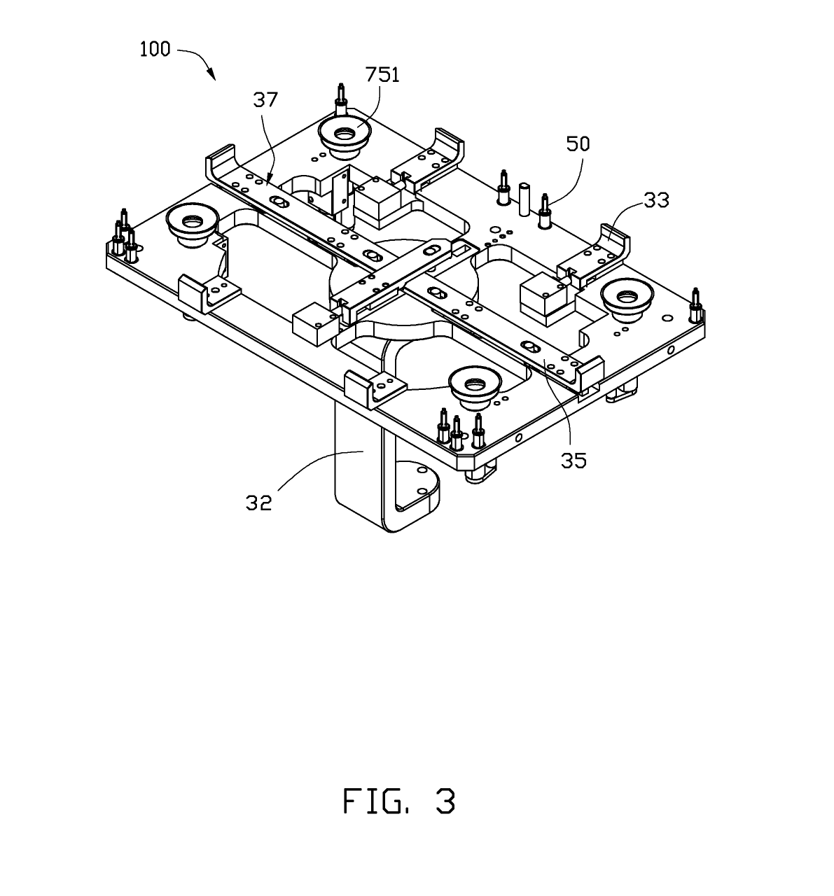

FIGS. 2 to 4 show the fetching mechanism 100 including a support base 30, a plurality of fetching members 50, and four adsorbing assemblies 70. The fetching members 50 are mounted on the support base 30 for fetching welding members 2033. The four adsorbing assemblies 70 are separately positioned on the support base 30, and spaced from the fetching members 50, for absorbing workpieces 300.

The support base 30 includes a support board 31, an U-shaped connecting member 32, four positioning members 33, and a stripe shaped guide member 35. The support board 31 is substantially in shape of rectangular and separately defining four through holes 311 and four mounting holes 313 through the support board 31. The mounting holes 313 are defined through four corners of the support board 31, respectively. The connecting member 32 connects the support board 31 and the robot arm 205. The positioning members 33 and the guide member 35 are positioned on a surface of the support board 31 away from the connecting member 32. The first two positioning members 33 are positioned adjacent to one edge of the support board 31, and the second two positioning members 33 are positioned adjacent to an opposite edge of the support board 31 and face to the first two positioning members 33. The guide member 35 is positioned on a substantial central portion of the support board 31, and opposite ends of the guide member 35 extends to other two edges of the support board 31. The positioning members 33 and the guide member 35 cooperative form a positioning space 37 for positioning the workpiece 300 when the adsorbing assembly 70 adsorbs the workpiece 300. In other embodiments, the number of the positioning members 33 may be two, three, five or others.

The fetching members 50 are arranged in positions on the support board 31 corresponding preset welding positions of the workpiece 300. The fetching member 50 includes a fixing portion 51 and a fetching portion 53 connecting with the fixing portion 51. The fixing portion 51 is connected to the support board 31 with one end, and located at a surface of the support board 31 away from the connecting member 32. The fetching portion 53 is connected with another end of the fixing portion 51. A shape of the fetching portion 53 fits over the operation groove of the welding member 2033 for fetching the welding members 2033.

Each adsorbing assembly 70 passes through one mounting hole 313 for adsorbing workpiece 300 in balance. Each adsorbing assembly 70 includes a driving member 71 and an adsorbing member 75. The driving member 71 is fixedly positioned on the surface connecting with the connecting member 32 of the support board 31. In the illustrated embodiment, the driving member 71 is a cylinder. The driving member 71 includes a base body 711 positioned on the support board 31 and a driving shaft 713 movably mounted in the base body 711. The adsorbing member 75 includes a connecting portion 751 and an adsorbing portion 753. The connecting portion 751 passes through and protrudes through the mounting hole 313. The first end of the connecting portion 751 is connected to the driver 71, for rising and falling in the mounting hole 313 driven by the driver 71, and the second end of the connecting portion 751 is connected the adsorbing portion 753. The adsorbing portion 753 is positioned adjacent to the positioning members 33 for adsorbing workpiece 300. In the illustrated embodiment, the connecting portion 751 is substantially hollow, each adsorbing assembly 70 further includes a vacuum generator (not shown) and an electromagnetic valve (not shown), the connecting portion 751 communicates with the vacuum generator (not shown)and the adsorbing portion 753, and the electromagnetic valve controls the vacuum generator work to adsorb or release the workpiece.

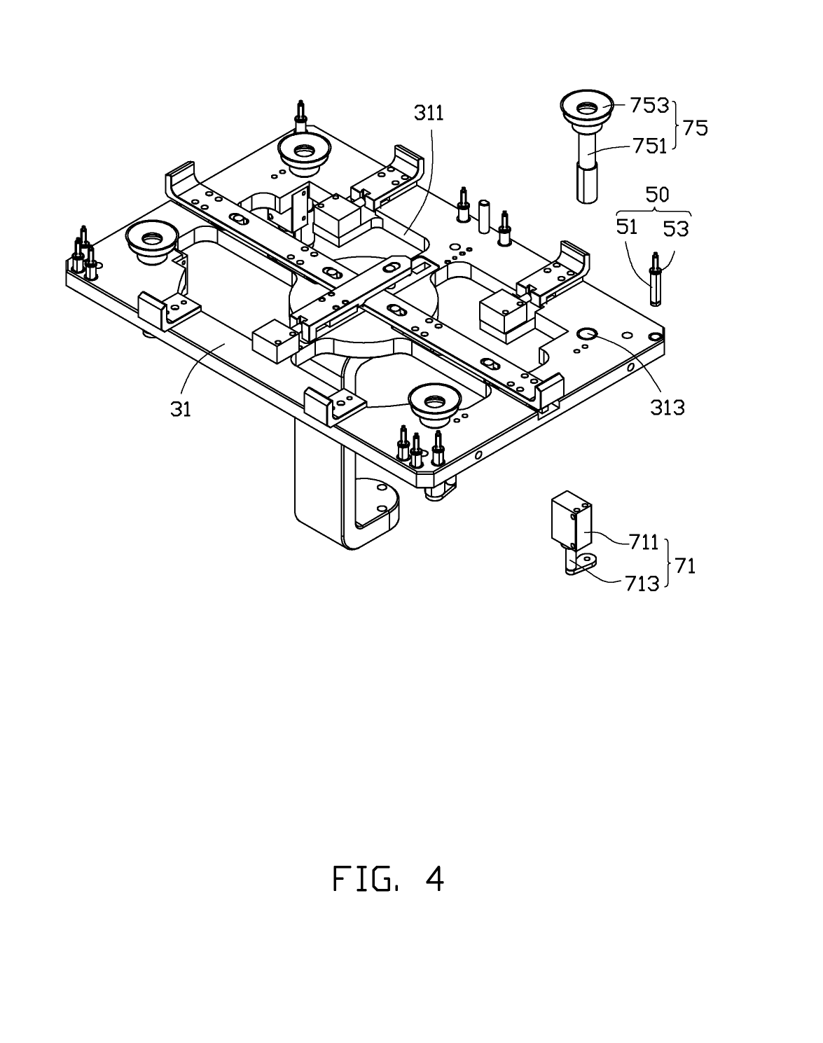

In assembly, the fetching members 50 are arranged in positions on the support board 31 corresponding to preset welding positions of the workpiece 300. The four adsorbing assemblies 70 are mounted on the support board 31. The connecting member 32 is connected between the support board 31 and the robot arm 205. FIG. 4 shows that a vertical distance from an end of the adsorbing portion 753 away from the support board 31 to the support board 31, is less than a vertical distance from the end of the fetching portion 53 away from the support board 31 to the support board 31 before use, for conventional fetching.

In use, the fetching mechanism 100 is moved above the loading platform 203, and each fetching member 50 fetches one welding member 2033. Then the fetching mechanism 100 is moved to a preset position above the conveyor belt 201. The adsorbing members 75 are driven to extend out to attach the workpiece 300. The vacuum generators generate vacuum to make the adsorbing members 75 adsorb the workpiece 300. The welding members 2033 correspond to the preset positions of the workpiece 300. The adsorbing members 75 are driven to drawback until the welding members 2033 fetched by the fetching members 50 attach or resist against the workpiece 300. The fetching mechanism 100 is moved to the welding machine 207 for welding. After the welding process, the fetching mechanism 100 is moved above the conveyor belt 201. The adsorbing members 75 are driven to extend out to make the welding members 2033 detaching from the fetching members 50. The electromagnetic valve controls vacuum generators stop work. The workpiece 300 is released and drops on the conveyor belt 201.

The fetching mechanism 100 used in the automatic welding system 200, can automatically fetch welding members 2033 and the workpiece 300. The fetching mechanism 100 also can make the welding members 2033 attach their preset welding positions for convenient welding. Therefore, the welding progress is reduced in time and labor. In addition, safety of production is ensured.

In other embodiments, the number and positions of the fetching members 50 and the adsorbing assemblies 70 are positioned according application.

In other embodiments, if the workpiece 300 is made of ferromagnetic material, the adsorbing member 75 can be designed to be made of electromagnetic material for adsorbing the workpiece 300.

While the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure, as defined by the appended claims.

What is claimed is:

1. A fetching mechanism for attaching welding members to a workpiece, the fetching mechanism comprising:
a support base;
at least one fetching member positioned on the support base; and
at least one adsorbing assembly positioned on the support base and spaced from the at least one fetching member, the at least one adsorbing assembly comprising a driving member positioned on the support base and an adsorbing member driven by the driving member, wherein the adsorbing member comprises a connecting portion positioned on and passing through the support base, and an adsorbing portion positioned at the support base at a same side with the at least one fetching member; the connecting portion is connected to the driving member, a vertical distance from an end of the adsorbing portion away from the support base to the support base is less than a vertical distance from an end of the at least one fetching member away from the support base to the support base; the adsorbing member extends out and adsorbs the workpiece driven by the driving member after the least one fetching member fetches one welding member of the welding members; and the adsorbing member is driven to drawback until the one welding member attaches the workpiece.

2. The fetching mechanism of claim 1, wherein the support base comprises a support board and a connecting member connected to the support board, the at least one fetching member and the adsorbing portion are separately positioned on a surface of the support board away from the connecting member, and the driving member is located on another surface of the support board.

3. The fetching mechanism of claim 2, wherein the support base further comprises a plurality of positioning members separately positioned on edges of the surface of the support board away from the connecting member.

4. The fetching mechanism of claim 3, wherein the support base further comprises a guide member positioned on the surface of the support board away from the connecting member, and the guide member and the plurality of positioning members cooperatively form a positioning space.

5. The fetching mechanism of claim 1, wherein the at least one fetching member comprises a fixing portion fixed on the support base and a fetching portion connecting with the fixing portion.

6. A fetching mechanism for attaching welding members to a workpiece, the fetching mechanism comprising:
a support base;
at least one fetching member positioned on the support base; and
at least one adsorbing assembly positioned on the support base and spaced from the at least one fetching member, the at least one adsorbing assembly comprising a driving member positioned on the support base and an adsorbing member driven by the driving member, wherein the at least one fetching member fetches one welding member of the welding members, the adsorbing member extends out and adsorbs the workpiece, and the adsorbing member is driven to drawback until the one welding member attaches the workpiece.

7. The fetching mechanism of claim 6, wherein the adsorbing member comprises a connecting portion and an adsorbing portion connecting with the connecting portion, the connecting portion is connected with the driving member and passes through the support base, and the adsorbing portion and the at least one fetching portion are positioned at a same side of the support base.

8. The fetching mechanism of claim 6, wherein the support base comprises a support board and a connecting member connected with the support board, the at least one fetching member and the adsorbing member are separately positioned on a surface of the support board away from the connecting member, and the driving member is located on another surface of the support board.

9. The fetching mechanism of claim 6, wherein the support base further comprises a plurality of positioning members separately positioned on edges of the surface of the support board away from the connecting member.

10. The fetching mechanism of claim 9, wherein the support base further comprises a guide member positioned on the surface of the support board away from the connecting member, and the guide member and the plurality of positioning members cooperatively form a positioning space.

11. The fetching mechanism of claim 6, wherein the at least one fetching member comprises a fixing portion fixed on the support base and a fetching portion connecting with the fixing portion.

12. The fetching mechanism of claim 6, wherein the driving member comprises a base body fixed on the support base and a driving portion movably connected with the base body, and the driving portion is connected with the adsorbing member.

13. An automatic welding system comprising:
a conveyor belt for conveying a workpiece;
a loading platform positioned at one side of the conveyor belt for loading welding members;
an robot arm positioned separately from the loading platform;
a welding machine; and
a fetching mechanism installed on the robot arm, the fetching mechanism comprising:
a support base connecting with the robot arm;
at least one fetching member positioned on the support base; and
at least one adsorbing assembly positioned on the support base and spaced from the at least one fetching member, wherein the at least one adsorbing assembly comprises a driving member positioned on the support base and an adsorbing member driven by the at least one driving member, the at least one fetching member fetches one welding member, the adsorbing member extends out and adsorbs the workpiece, and the adsorbing member is driven to drawback until the one welding member attaches the workpiece.

14. The automatic welding system of claim 13, wherein the adsorbing member comprises a connecting portion and an adsorbing portion connected with the connecting portion, the connecting portion is connected with the driving member and passes through the support base, and each adsorbing portion and the at least one fetching portion are positioned at a same side of the support base.

15. The automatic welding system of claim 14, wherein a vertical distance from an end of the adsorbing portion away from the support base to the support base, is less than a vertical distance from one end of at least one fetching member away from the support base to the support base.

16. The automatic welding system of claim 13, wherein the support base comprises a support board and a connecting member connected between the robot arm and the support board, the at least one fetching member and the adsorbing member are separately positioned on a surface of the support board away from the connecting member, and each driving member is located on another surface of the support board.

17. The automatic welding system of claim 16, wherein the support base further comprises a plurality of positioning members separately positioned on edges of the surface of the support board away from the connecting member.

18. The automatic welding system of claim 17, wherein the support base further comprises a guide member positioned on the surface of the support board away from the connecting member, and the guide member and the plurality of positioning members cooperatively form a positioning space.

19. The automatic welding system of claim 13, wherein the at least one fetching member comprises a fixing portion fixed on the support base and a fetching portion connecting with the fixing portion.

20. The automatic welding system of claim 19, wherein the driving member comprises a base body fixed on the support base and a driving portion movably connected with the base body, and the driving portion is connected with the adsorbing member.
